(19) United States
(12) Patent Application Publication
(10) Pub. No.: US 2008/0065525 A1
(43) Pub. Date: Mar. 13, 2008

(54) Methods of pricing and allocating capacity

(76) Inventors: Reynold Roeder, Portland, OR (US); Lorry A. Wilson, Calgary (CA)

Correspondence Address: KOLISCH HARTWELL, P.C., 520 SW YAMHILL STREET, Suite 200, PORTLAND, OR, 97204, US

(21) Appl. No.: 11/700,542

(22) Filed: Jan. 30, 2007

Related U.S. Application Data
(60) Provisional application No. 60/763,220, filed on Jan. 30, 2006.

(51) Int. Cl. G06Q 40/00

(52) U.S. Cl. 705/37; 705/38

(57) ABSTRACT

A method of assigning a settled unit capacity price for the purchase of transmission capacity by resource suppliers including the steps of specifying an available capacity for bidding, receiving bids from a plurality of resource suppliers, selecting the bids with the highest personal unit capacity prices until the aggregate desired capacity of the selected bids at least equals the available capacity or until all the bids have been selected if the aggregate desired capacity does not at least equal the available capacity, and assigning the settled unit capacity price to be a function of the personal unit capacity prices submitted in the selected bids. In some examples, the method includes allocating transmission capacity to resource suppliers. In some examples, the method includes assigning a settled net unit capacity price for each of different term durations and allocating transmission capacity to resource suppliers.

### RELATED APPLICATIONS

This application claims priority under 35 U.S.C. § 119(e) to U.S. Provisional Application No. 60/763,220 filed on Jan. 30, 2006, the disclosure of which is incorporated herein by reference for all purposes.

### BACKGROUND

With the deregulation of power markets and the disaggregation of vertically integrated public utilities during the 1990's and early 2000's, much attention has been given to the development of the “Merchant Transmission” industry. For much of this same time period, incumbent utilities underinvested in their transmission systems because they were unable to capture all the system benefits created when a new addition to the system was made. As a result, the reliability of the systems has deteriorated while loads have increased. Various articles and periodicals have predicted the emergence of Merchant Transmission as a way of developing and financing the necessary electrical grid system upgrades.

Merchant Transmission is the development of transmission systems without financial risk to ratepayers. The Merchant Transmission model generally places the financial risk that would otherwise fall to the ratepayers on to developers and owners of transmission systems. The Federal Energy Regulatory Commission (“FERC”) has openly stated their support of Merchant Transmission and the formation of “Independent Transmission Companies” or “ITCs” (TransEnergie Ltd., 91 FERC ¶61,230 at 61,838 (2000)—merchant transmission “can play a useful role in expanding competitive generation alternatives for customers”). ITCs that own only transmission systems are allowed higher rates of return. Merchant Transmission companies' rates are not regulated, whereas ITC rates are regulated. FERC requires that Merchant Transmission company rates, though not regulated, must be set on an “open and fair basis.”

Setting rates on an “open and fair basis” has typically been accomplished by holding an initial auction of capacity, typically referred to as an “Open Season”. Open Seasons have historically been used by the gas industry to establish rates for pipeline and storage capacity. The rates established through this process have typically been evaluated based on the net present value of the contractual payments for the capacity and term bid.

Through the Open Season process, a developer hopes to establish sufficiently firm contractual obligations of capacity users to attract the debt and equity capital necessary to complete the transmission system project. As such, the results of the Open Season are critical to the success and feasibility of the project.

Initial attempts to develop merchant transmission projects utilizing an Open Season process failed to attract sufficient bids to support the necessary capital. Neptune (FERC Docket ER01-2099) first attempted an Open Season process in 2001 based on the gas model, but failed to attract sufficient bids. Similarly, Conjuction LLC (FERC Docket ER03-452) attempted an open season in February 2004, again using the net present value model of the gas industry and also failed. In addition, LECTRIX LLC held an Open Season for capacity of a converter station linking the Alberta power grid to the Saskatchewan power grid in 2002 and failed to attract any bids, again based on the gas net present value model.

One reason that prior transmission system development projects were unsuccessful was because potential bidders elected not to participate given the uncertain credit consequences that could result. The various potential bidders were keenly aware that the project was only financially feasible if sufficient contractual commitments were obtained through the Open Season process. The potential bidders also understood that it was the credit quality of their balance sheet that would ultimately drive the underwriting of the capital attracted to the project. The potential bidders were thus reluctant to utilize their balance sheet credit capacity for the perceived minimal returns they might obtain after competitively bidding for capacity.

Another reason that prior transmission system development projects did not succeed was the fact that the outcome could be different unit capacity prices for different bidders. Potential bidders understood that if they didn't bid for all the capacity of the project, the likely outcome of the award of the auction would be that each successful bidder would pay a different price for basically fungible capacity. As such, no bidder wanted to take the chance that they would be using their balance sheet to subsidize the capacity award of another bidder and competitor. For example in an Open Season process using the net present value evaluation method, the winning bidder could bid one price to win the majority of the project capacity and a competitor could win the remainder of the capacity with a much lower bid.

In July 2000, Transenergie met with some success when they sold the entirety of the capacity of their undersea transmission line linking New England to Long Island (a.k.a Cross-Sound Cable LLC) to the winning bidder, Long Island Power Authority. However, Long Island Power Authority was the only bidder to submit a conforming bid and ultimately, it appears that the capacity was sold after bilateral negotiations (FERC Docket No. ER00-1-003). This Open Season was successful because a single bidder was able to secure all of the project benefits, and thereby knew they were not subsidizing any other bidder who might get access to the same capacity, but at a lower price.

Accordingly, there is a need for a method of pricing and allocating capacity that addresses the observed shortcomings of prior such methods. Specifically, there is a need for “a fair and open” method of pricing and allocating capacity in compliance with any rules and regulations that may exist, such as FERC rules for determining merchant tariff rates by using an auction process. There is also a need for a method that sets an equal settled capacity price for each unit of capacity sold to obviate the risk of one bidder inadvertently subsidizing another competitive bidder. A further need exists for a method that specifies a threshold capacity that must be awarded for the project to move forward, which may, for example, allow a bidder to evaluate the probability of a transmission system being built. Moreover, a need exists for a method that limits participation to bidders that satisfy certain credit criteria.

The methods described in the present application meet these needs as demonstrated by the successful Open Season that was held in connection with the Montana Alberta Tie line project FERC Docket No. ER05-764. The transmission line commenced construction after a successful open season in accordance with the methods described herein and in U.S. Provisional Application No. 60/763,220 from which the present application claims priority. No prior method of pricing and allocating transmission capacity with a plurality of winning bidders had proved successful until the methods described herein were used in connection with the Montana Alberta Tie line project.

The following patents and patent application publications disclose examples of auction methods, and are incorporated in their entirety herein by reference for all purposes: U.S. Pat. No. 6,718,312 and U.S. Publication Nos. 2002/0029183, 2003/0229576, 2004/0054617, 2004/0220869, 2005/0102215, 2005/0160030, 2005/0246187, 2005/0273416, 2005/0289043, 2006/0095363 and 2006/0095366.

### SUMMARY

The present disclosure is directed to a method of assigning a settled unit capacity price for the purchase of transmission capacity by resource suppliers including the steps of specifying an available capacity for bidding, receiving bids from a plurality of resource suppliers, selecting the bids with the highest personal unit capacity prices offered until the aggregate desired capacity of the selected resource suppliers at least equals the available capacity or until all the bids have been selected if the aggregate desired capacity does not at least equal the available capacity, and assigning the settled unit capacity price to be a function of the personal unit capacity prices offered in the selected bids. In some examples, the method includes allocating transmission capacity to resource suppliers. In some examples, the method includes assigning a settled unit capacity price for each of different term durations and allocating transmission capacity to resource suppliers.

### BRIEF DESCRIPTION OF THE DRAWINGS

FIG. 1 is schematic view of a conduit extending towards resource consumers and a plurality of resource suppliers coupled to the transmission line.

FIG. 2 is a flow diagram of a method of assigning a settled unit capacity price for the purchase of transmission capacity by resource suppliers.

FIG. 3 is a flow diagram of a method of allocating transmission capacity at an equal settled unit capacity price to resource suppliers.

FIG. 4 is a flow diagram of a method of allocating transmission capacity available for different term durations at an equal settled unit capacity price for each term duration to resource suppliers.

FIG. 5 is a flow diagram of a method of assigning rights of use to bidders at an equal settled unit price.

FIG. 6 is a chart of resource supplier bids for transmission capacity.

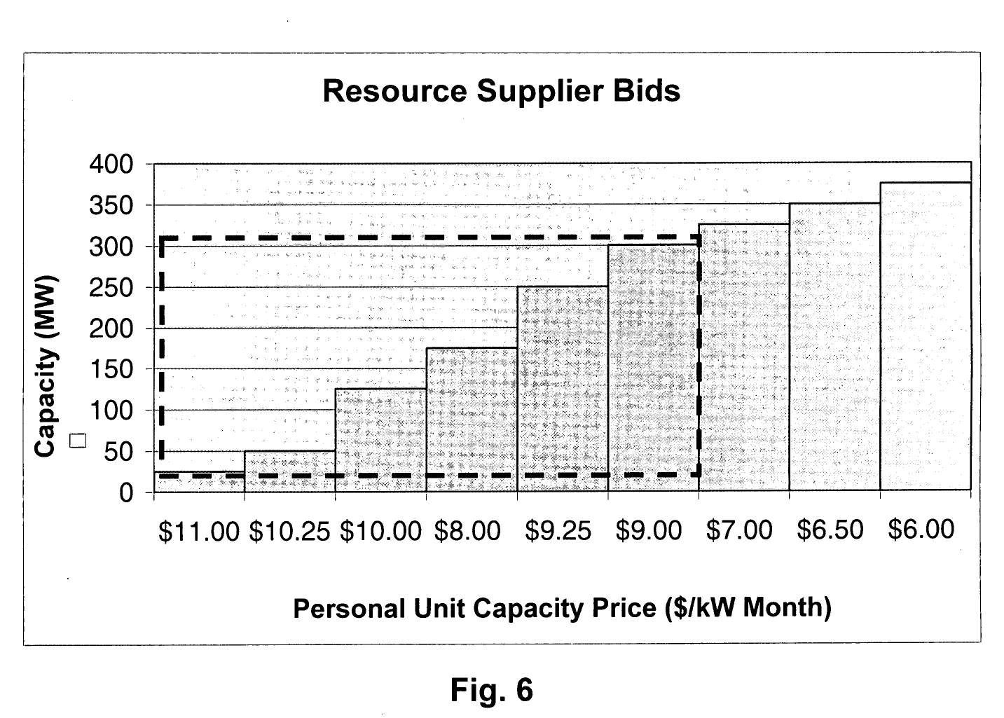

### DETAILED DESCRIPTION

Methods of pricing and allocating capacity may be used by transmission capacity providers to set prices for units of transmission capacity and to allocate transmission capacity among resource suppliers. The methods described herein may be used in regulated and unregulated transactions and may find special appeal in transactions designed to be on an “open and fair basis” pursuant to FERC standards.

The methods of pricing and allocating capacity described herein are applicable for the transmission of resources. Resources include matter, energy, or electromagnetic radiation. For example, the transmission capacity of matter may describe how much solids, liquids, or gas, such as natural gas, a system may transmit. Transmission of energy includes transmitting electricity, whether direct current or alternating current. Transmitting electromagnetic radiation includes transmitting optical data, for example via fiber optic networks, or transmitting radio waves. Radio spectrum license sales represents one application of the methods described in this disclosure.

The methods of pricing and allocating capacity are also applicable for the assignment of rights of use, such as in the case of a manufacturing queue or a restricted pathway. Rights of use include the right to use manufacturing capabilities, airport runways, and navigable waterways or roadways. For example, an assigner may assign the right to use manufacturing capabilities for a certain time or in a certain order relative to other users, e.g. placing manufacturing users in queue. In other examples, an assigner may assign the right to a time slot to land a plane at an airport, or the right to use navigable waterways or roadways.

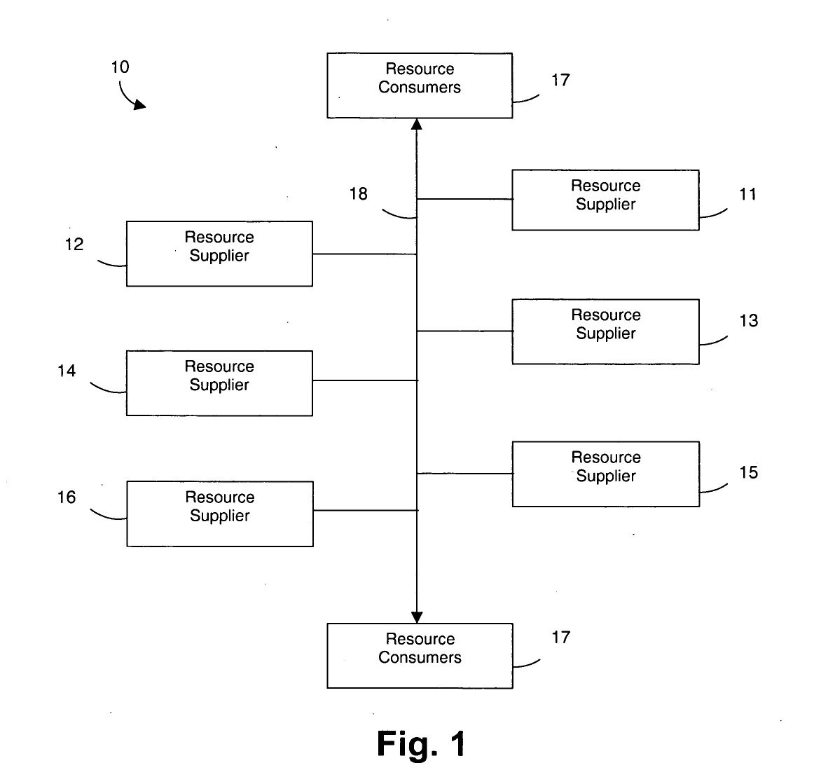

FIG. 1 depicts a resource transmission system 10 including resource suppliers 11-16, resource consumers 17, and conduit 18. A resource supplier may procure, mine, manufacture, synthesize, assemble, refine, produce, or encode a resource. Resource suppliers 11-16 typically supply resources to resource consumers 17. In some examples, resource suppliers 11-16 use conduit 18 to deliver resources to resource consumers 17.

Conduit 18 is any structure or device configured to transmit resources. Suitable conduits 18 include conveyors, pipes, wires, power lines, fiber optic cables, or radio frequency transmitters. Conduit 18 is not limited to a single conduit, but in fact may include a network of conduits facilitating unidirectional, bidirectional, or omnidirectional transmission of resources. Conduit 18 typically has a total transmission capacity. Before conduit 18 is constructed, the transmission capacity provider may set a threshold capacity that must first be purchased or subject to contractual obligation to render construction of conduit 18 feasible.

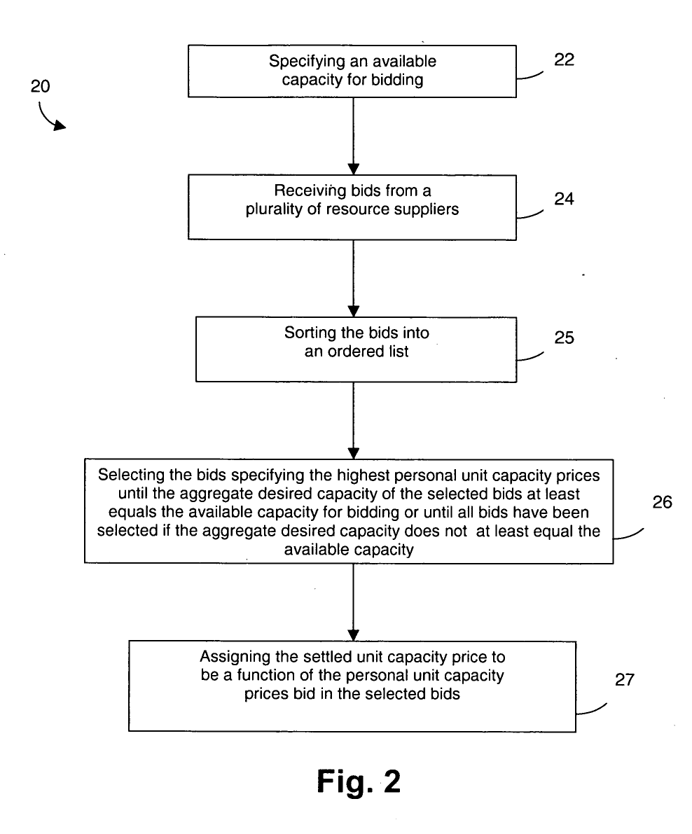

FIG. 2 shows a method 20 for assigning a settled unit capacity price for the purchase of transmission capacity by resource suppliers. The settled unit capacity price defines how much a resource supplier must pay to transmit a unit of a resource via conduit 18. The settled unit capacity price is generally an equal price that all resource suppliers must pay, but in some examples there may be different settled unit capacity prices for different term durations for which capacity may be purchased. In some examples, only resource suppliers who make selected bids are entitled to purchase transmission capacity at the settled unit capacity price.

Method 20 starts by a transmission provider specifying 22 an available capacity for bidding. In some examples, the available capacity equals the total capacity of conduit 18, but in other examples the available capacity is less than the total capacity. The available capacity may be based on how much capital the transmission capacity provider determines is necessary to make construction of conduit 18 financially feasible. For example the transmission provider may set a minimum threshold capacity that must be bid before any bids are accepted, such threshold estimated to be that level of contractual commitments necessary to attract funding of the project.

Additionally or alternatively to the available capacity, the transmission capacity provider may specify other parameters that a bid must satisfy to qualify for selection. For example, the transmission capacity provider may specify that capacity must be bid according to a minimum capacity block. Additionally or alternatively, the transmission capacity supplier may specify a minimum price representing the minimum personal unit capacity price that must be bid for a bid to qualify for selection. In some examples, a transmission capacity supplier may specify different term durations for which a resource supplier my purchase transmission capacity. For example, a transmission capacity supplier may offer crude oil transport capacity through its pipeline for 1, 3, and 5 year terms.

After the available capacity is specified 22, method 20 continues by receiving 24 bids from a plurality of resource suppliers. Each bid typically specifies a desired capacity that a resource supplier wants to purchase. Each bid also typically specifies a personal unit capacity price that the resource supplier is willing to pay for the desired capacity it bid.

Method 20 may optionally include the step of sorting 25 the bids into an ordered list. The ordered list typically starts with the bid containing the highest personal unit capacity price submitted by a resource supplier and progresses towards the bid containing the lowest personal unit capacity price. The ordered list need not include all bids made, but instead could include a subset of all the bids. For example, the ordered list could include the bids with the highest personal unit capacity prices until the desired capacities of all such bids at least equaled the available capacity. A user of the method may find it more systematic or convenient to sort all bids into an ordered list, but including all bids and sorting the bids in the first place is not necessary.

After the bids are received 24, method 20 continues by selecting 26 the bids with the highest personal unit capacity prices until the aggregate desired capacity of the selected bids at least equals the available capacity. In some examples, selecting 26 bids will stop once all bids have been selected if the aggregate desired capacities of the selected bids does not at least equal the available capacity. The selected bids are determined by sequentially adding the desired capacity bid by the resource supplier who bid the highest personal unit capacity price to the desired capacity bid by the resource supplier who bid the next highest personal unit capacity price. In this manner, the highest bids of personal unit capacity price are selected while accounting for the capacity actually available.

In some instances, the aggregate desired capacities specified by bidders in the selected bids may exceed the available capacity. This can occur when more than one bid has the same personal unit capacity price, which happens to be the lowest personal unit capacity price specified by bidders in the selected bids. By selecting both such bids, the aggregate desired capacity of the selected bids can exceed the available capacity. Exceeding the available capacity can also occur when during the selection process the difference between the aggregate desired capacity total for all higher personal unit capacity prices and the available capacity is less than the desired capacity bid in the lowest selected desired unit capacity price bid.

Method 20 includes the step of assigning 27 the settled unit capacity price to be a function of the personal unit capacity prices bid in the selected bids. Many different functions are envisioned. In some examples, the settled unit capacity price will be assigned to be the minimum desired unit capacity price bid in the selected bids. In other examples, the settled unit capacity price is assigned to be the average desired unit capacity price bid in the selected bids. Other functions, such as the maximum or mean desired capacity unit price of the selected bids, are also suitable in different situations.

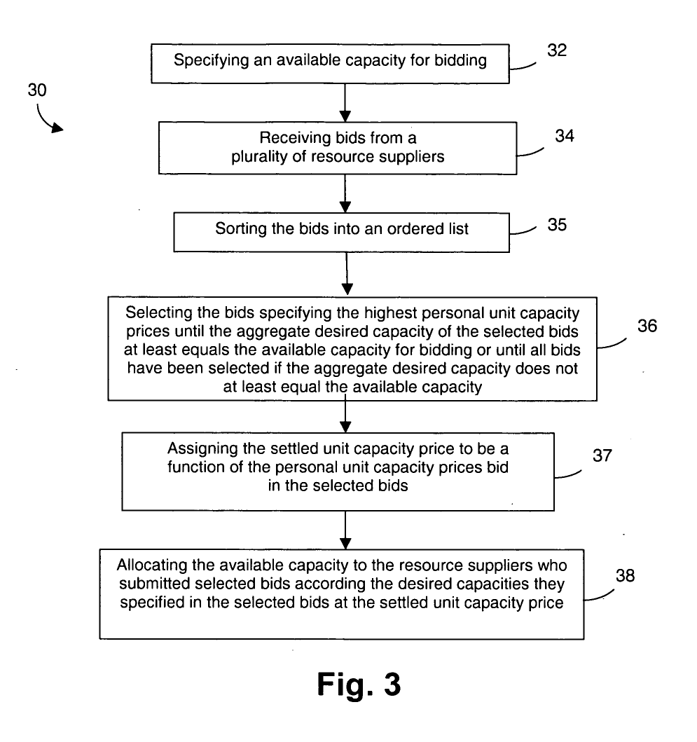

FIG. 3 shows a method 30 for allocating transmission capacity at an equal settled unit capacity price to resource suppliers. Portions of method 30 are substantially similar to portions of method 20 described above and, for the sake of brevity, will not be discussed at length further.

Method 30 initiates by specifying 32 an available capacity for bidding. Additional parameters may also be specified from the outset, such as credit criteria necessary for a resource supplier's bid to qualify for selection. Additional or alternative parameters include minimum prices, available term durations, minimum capacity blocks that must be bid, and a threshold capacity, which may be zero and which must be collectively bid on before capacity will be allocated.

Method 30 proceeds by receiving 34 bids from a plurality of resource suppliers. Typically the bids specify a desired capacity and a personal unit capacity price. Depending on the specified parameters, the bids may also specify a term duration and whether the resource supplier would accept a pro-rata allocation in the event it was not entitled to the entire allocation of capacity on which it bid.

The received bids may optionally be sorted 35 into an ordered list. In some examples, the bids are ordered based on their personal unit capacity price. In such examples, the list may start with the bid containing the highest personal unit capacity price and progress towards the bid containing the lowest personal unit capacity price.

Method 30 typically includes the step of selecting 36 the bids with the highest personal unit capacity prices until the aggregate desired capacity of the selected bids at least equals the available capacity. Selecting 36 bids may conclude when all bids have been selected if the aggregate desired capacity of the selected bids does not at least equal the available capacity. Selecting 36 bids in this manner results in selected bids.

The personal unit capacity prices specified by resource suppliers in the selected bids may be used to assign 37 the settled unit capacity price. In some examples, the settled unit capacity price is assigned 37 to be a function of the personal unit capacity prices specified by bidders in the selected bids. One such function would be assigning 37 the settled unit capacity price to be the minimum personal unit capacity price specified by resource suppliers in the selected bids.

The example of method 30 shown in FIG. 3 includes the step of allocating 38 transmission capacity to resource suppliers at the settled unit capacity price. The allocation 38 is typically made according to the desired capacities specified by resource suppliers in the selected bids. However, other allocations are contemplated. For example, when the aggregate desired capacities specified by resource suppliers in the selected bids exceeds the available capacity, a pro-rata allocation of the available capacity may be used.

A pro-rata allocation may be made by allocating the available capacity to resource suppliers in proportion to their desired capacities bid in the selected bids. If different term durations are available, priority may be given to the selected bids with offers for capacity at the longest term duration. In other examples, priority may be given to the selected bids at the shortest term duration. Priority may be given to the selected bids of the longest term duration by first making a pro-rata allocation based on such bids up to the desired capacities bid therein, and then subsequently allocating the remaining capacity based on the remaining selected bids of shorter term durations.

A resource supplier's bid may indicate that it would not accept an allocation less than the desired capacity that it specified in its bid. In that instance, method 30 may dictate that such resource supplier's bid be rejected in its entirety from the pro-rata allocation and the remaining resource suppliers who comprising the population of selected bids would receive a higher allocation. In the event that all bidders indicated that they would not accept less than the desired capacities that they bid, a random selection process may be employed to determine which resource suppliers will receive allocations equal to the desired capacities they bid.

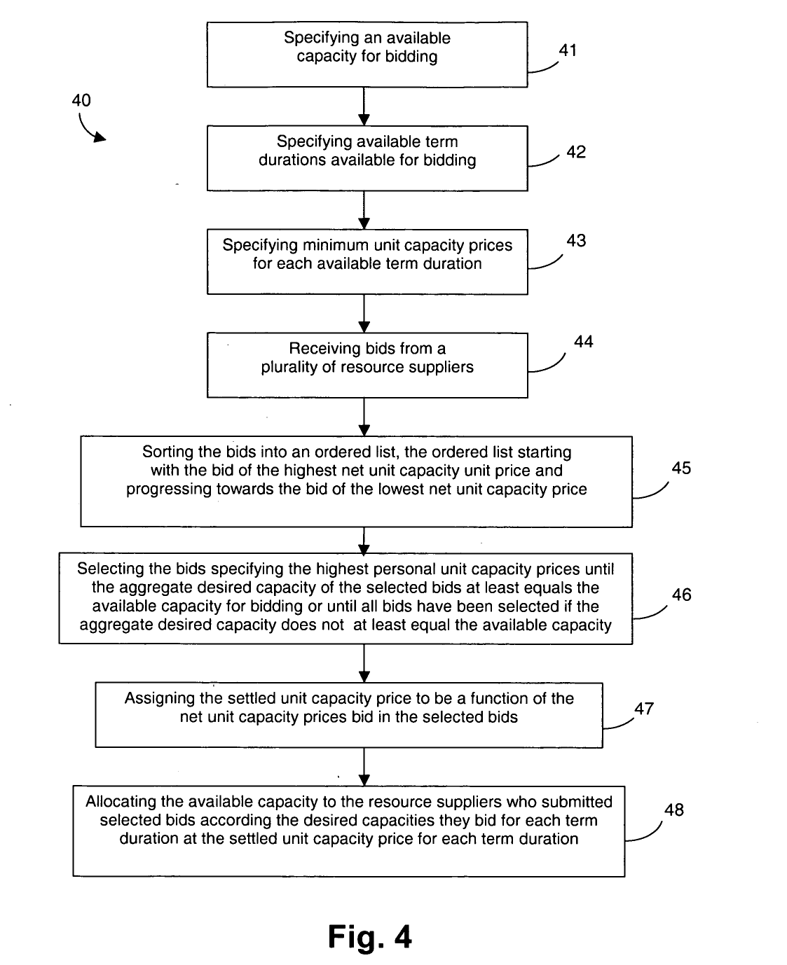

FIG. 4 shows a method 40 for allocating transmission capacity for different available term durations at an equal settled unit capacity price for each term duration to resource suppliers. Portions of method 40 are substantially similar to portions of methods 20 and 30 described above and, for the sake of brevity, will not be discussed at length further.

Method 40 typically starts by specifying initial parameters governing its operation. For example, as shown in FIG. 4, method 40 includes specifying 41 an available capacity for bidding, specifying 42 term durations available for bidding, and specifying 43 minimum unit capacity prices for each term duration. A transmission capacity supplier may wish to specify additional or alternative parameters. For example, a transmission capacity supplier may specify a minimum capacity block that must be bid for the bid to qualify for selection or a threshold capacity that must be bid on before any transmission capacity will be allocated. Such threshold capacity could be specified at zero.

Receiving 44 bids from a plurality of resource suppliers is typically accomplished after initial parameters are specified 41-43. Bids may specify a desired capacity, the term duration for which the resource supplier is bidding, and a personal unit capacity price the resource supplier is willing to pay. Bids may also specify whether the resource supplier would accept a pro-rata allocation in the event it was not entitled to the entire allocation of capacity on which it bid.

Though not necessary, method 40 may include the step of sorting 45 the bids into an ordered list. The ordered list in method 40 may be ordered based on a net unit capacity price of the bids. In some examples, the net unit capacity price equals the personal unit capacity price minus the minimum unit capacity price for the term duration bid upon. Net unit capacity price may be a useful quantity for comparing bids made for different term durations. The ordered list may be ordered starting with the bid of the highest net unit capacity price and progressing towards the bid of the lowest net unit capacity price.

Method 40 may proceed by selecting 46 the bids with the highest net unit capacity prices until the aggregate desired capacity of the selected bids at least equals the available capacity. In some examples, selecting bids will conclude after all bids have been selected if the aggregate desired capacity of the selected bids does not at least equal the available capacity. Selecting 46 bids in this manner results in a population of selected bids.

The net unit capacity price bids of the selected resource suppliers may be used to assign 47 the settled unit capacity prices for each term duration. In some examples, the settled unit capacity prices are assigned to be a function of the net unit capacity prices bid by the selected resource suppliers. In one example, the settled unit capacity price for each term duration is equal to the minimum price for each term duration plus the minimum net unit capacity price bid by the selected resource suppliers. Thus, in one example of method 40, the minimum net unit capacity price is added to the minimum prices of each term duration to assign 47 the settled unit capacity prices for each term duration.

Method 40 typically includes the step of allocating 48 transmission capacity to resource suppliers who's bids were selected according the desired capacities they bid for each term duration at the settled unit capacity price for each term duration. In this manner, the resource suppliers who's bids were selected may purchase transmission capacity allocated 48 to them at the term duration and corresponding settled unit capacity price for that term duration. In the event that the aggregate desired capacity of the selected bids exceeds the available capacity, a pro-rata allocation of the available capacity may be used.

A pro-rata allocation may be made by allocating the available capacity to resource suppliers in proportion to the desired capacities specified in the selected bids. Priority may-be given to the selected bids of the longest term duration by first making a pro-rata allocation based on those selected bids up to the desired capacities bid therein and then subsequently allocating the remaining capacity based on the remaining selected bids. In other examples, priority may be given to selected bids of the shortest-duration. If a resource supplier indicated on its bid that it would not accept an allocation of less than the desired capacity that it bid, that resource supplier's bid may be rejected and the remaining selected bids may receive a higher allocation. In the event that all resource suppliers indicated that they would not accept less than the desired capacities that they bid, a random selection process may be employed to determine which resource suppliers will receive allocations equal to the desired capacities they bid.

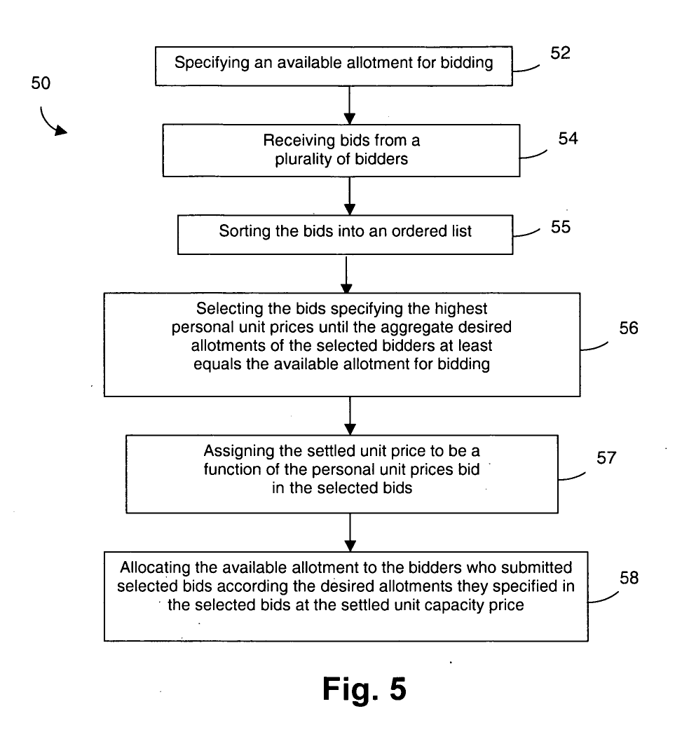

FIG. 5 shows a method 50 for assigning rights of use to bidders at an equal settled unit price. As mentioned previously, an assigner may assign the right to use manufacturing capabilities for a certain time or in a certain order relative to other users. In other examples, an assigner may assign the right to a time slot to land a plane at an airport, or the right to use navigable waterways or roadways.

Method 50 starts by specifying 52 an offered allotment of the right of use being offered for bidding. The offered allotment may be less than or equal to the entire right to use held by the assigner. The offered allotment may be time periods of use, orders of use, priorities of use, or rights of refusal. The assigner may specify different term durations, requisite credit criteria, and minimum allotment blocks that must be bid for a bid to qualify for selection.

Method 50 continues by receiving 54 bids from a plurality of bidders. Typically, each bid specifies a desired allotment and a personal unit price that the bidder is willing to pay for the desired allotment. In some instances, bids will specify whether a bidder will accept pro-rata allocations of the desired capacity it bid and/or include credit criteria information. Sorting 55 the bids into an ordered list progressing from the bid with the highest personal unit price towards the bid with the lowest personal unit price may optionally be performed.

After or during receipt 54 of bids, method 50 may include the step of selecting 56 the bids with the highest personal unit prices until the aggregate desired allotment of the selected bids at least equals the offered allotment. In some examples, selecting 56 bids will conclude when all the bids have been selected if the aggregate desired allotment of the selected bids does not at least equal the offered allotment. Selecting bids according to this step results in selected bids.

Method 50 may proceed by assigning 37 a settled unit price to be a function of the personal unit prices bid in the selected bids. For example, the settled unit price may be assigned to be the minimum personal unit price bid in the selected bids. The settled unit price may be an equal price used to allocate right of use allotments to bidders who bid selected bids.

As shown in FIG. 5, method 50 may include the step of allocating 58 the offered allotment at the equal settled unit price to the bidders who bid selected bids according to the desired allotments bid in the selected bids. If the aggregate desired allotment of the selected bids exceeds the offered allotment, a pro rata allocation may be made.

An example of one embodiment of a method for pricing and allocating capacity is provided to further describe its features and operation. The example pertains to the pricing and allocation of energy transmission capacity, with transmission capacity being expressed in megawatts (“MW”) and pricing being expressed in dollars per kilowatt-month (“$/kW-month”). In the example, a transmission capacity provider is offering for sale energy transmission capacity running from a northern region to a southern region. A plurality of resource suppliers seek to deliver energy they have produced to their energy customers and thus participate in the pricing and allocation method set forth by the transmission capacity provider.

TABLE 1
Initial Parameters

| Parameter | Value | Units |
|---|---|---|
| Minimum capacity blocks | 25 | MW |
| Term durations | 5 & 10 | years |
| 10 year minimum price per | $4.93 | $/kW-month |
| unit capacity | | |
| 5 year minimum price per | $6.38 | $/kW-month |
| unit capacity | | |
| Available capacity | 300 | MW |

As shown in Table 1, the transmission capacity provider has specified certain parameters from the outset that govern the pricing and allocation of energy transmission capacity. One such parameter is that resource suppliers must bid for energy transmission capacity in minimum capacity blocks of 25 MW. Another parameter is that transmission capacity will be offered in either 5 or 10 year terms. Resource suppliers are allowed to separately bid for transmission capacity in both the 5 year term and the 10 year term, but need not bid for both. Each allowed term duration is subject to separate minimum prices, which represent the minimum price the transmission capacity provider will accept for each term. In the present example, for the 5 year term, trnasmission capacity will only be sold for not less than $6.38/kW-month and for the 10 year term, it will only be sold for not less than $4.93/kW-month. The available capacity is 300 MW, which is the capacity that the transmission capacity provider is offering for sale.

Additional parameters govern bidding for transmission capacity by resource suppliers in the present example. One parameter is that bids will be accepted in a single round. Resource suppliers must bid a desired capacity and a personal unit capacity price. Resource suppliers may bid as many capacity blocks as desired, provided minimum quantities and minimum price requirements are met. Thus, a resource supplier desiring 100 MW of capacity may bid from 1 to 4 capacity blocks, each block having its own bid price, e.g. 100 MW at $8.00 per kW-month, 75 MW at $8.50per kW-month and 25 MW at $9.00 per kW-month, or 50 MW at $8.75 per kW-month and 50 MW at $9.25 per kW-month. Further, the transmission capacity provider reserves the right to not proceed with pricing and allocation of transmission capacity after the bids are received.

TABLE 2
Bids Ordered by Resource Supplier

| | | Desired | | | Aggregate |
|---|---|---|---|---|---|
| Re- | Personal Unit | Capac- | | Net Unit | Desired |
| source | Capacity Price | ity | Term | Capacity Price | Capacity |
| supplier | ($/kW-month) | (MW) | (Years) | ($/kW-month) | (MW) |
| 1 | 8.00 | 50 | 10 | 3.07 | 50 |
| 1 | 6.38 | 50 | 5 | 0.00 | 100 |
| 2 | 9.00 | 50 | 5 | 2.62 | 150 |
| 3 | 10.00 | 75 | 5 | 3.62 | 225 |
| 3 | 7.00 | 25 | 10 | 2.07 | 250 |
| 4 | 6.00 | 25 | 10 | 1.07 | 275 |
| 4 | 10.25 | 25 | 5 | 3.87 | 300 |
| 5 | 11.00 | 25 | 5 | 4.62 | 325 |
| 6 | 9.25 | 75 | 5 | 2.87 | 400 |
| 6 | 6.50 | 25 | 10 | 1.57 | 425 |

The bids made by each of the resource suppliers, also referred to as bidders, are detailed in Table 2. In the present example, there are 6 resource suppliers and they make a total of 10 bids. Resource suppliers 1, 3, 4, and 6 each bid for capacity in both 5 and 10 year terms while resource suppliers 2 and 5 only bid for capacity in the 5 year term. In Table 2, the bids are ordered by bidder number in ascending fashion without respect to the values of the bids.

The net unit capacity price for each resource supplier is calculated by subtracting the personal unit capacity price from the minimum price for the respective term. For example, resource supplier 1 bid a personal unit capacity price of $8.00/kW-month for a 10 year term and the minimum price for the 10 year term was $4.93/kW-month. Thus, the net unit capacity price for resource supplier 1 is $8.00−$4.93=$3.07/kW-month. Similarly, resource supplier 1 bid a personal unit capacity price of $6.38/kW-month for a 5 year term and the minimum price for the 5 year term was $6.38/kW-month, which results in a net unit capacity price of $6.38−$6.38=0.00 $/kW-month.

The aggregate desired capacity is determined by adding the desired capacity bid in each bid of a resource supplier in the ordered list. For example, resource supplier 1 bid a desired capacity of 50 MW for a 10 year term in its first bid, which results in an aggregate desired capacity after that first bid of 50 MW. The aggregate desired capacity after resource supplier 1's second bid, wherein it bid a desired capacity of 50 MW for a 5 year term, equals 50+50=100 MW. Likewise, the aggregate desired capacity after resource supplier 2's bid of 50 MW for a 5 year term equals 50+50+50=150 MW. After the final bid by resource supplier 6, the aggregate desired capacity equals 425 MW, which is greater than the available capacity of 300 MW. Thus, in this example the demand for transmission capacity exceeds the supply available for bidding.

TABLE 3
Bids Ordered by Net Unit Capacity Price

| | | Desired | | | Aggregate |
|---|---|---|---|---|---|
| Re- | Personal Unit | Capac- | | Net Unit | Desired |
| source | Capacity Price | ity | Term | Capacity Price | Capacity |
| supplier | ($/kW-month) | (MW) | (Years) | ($/kW-month) | (MW) |
| 5 | $11.00 | 25 | 5 | $4.62 | 25 |
| 4 | $10.25 | 25 | 5 | $3.87 | 50 |
| 3 | $10.00 | 75 | 5 | $3.62 | 125 |
| 1 | $8.00 | 50 | 10 | $3.07 | 175 |
| 6 | $9.25 | 75 | 5 | $2.87 | 250 |
| 2 | $9.00 | 50 | 5 | $2.62 | 300 |
| 3 | $7.00 | 25 | 10 | $2.07 | 325 |
| 6 | $6.50 | 25 | 10 | $1.57 | 350 |
| 4 | $6.00 | 25 | 10 | $1.07 | 375 |
| 1 | $6.38 | 50 | 5 | $0.00 | 425 |

The method optionally proceeds by sorting the bids into an ordered list starting with the highest net unit capacity price and ending with the lowest net unit capacity price as shown in Table 3. The resource supplier column is no longer in ascending order by resource supplier number, but rather is ordered corresponding to the net unit capacity prices in descending order. Also apparent from Table 3 is that the personal unit capacity price column is not in strict descending order because the personal unit capacity prices pertain to different term durations with different minimum prices. Thus, net unit capacity price and personal unit capacity prices do not necessarily parallel each other when ordered in descending fashion.

Resource supplier 2's bid is italicized in Table 3 because it results in an aggregate desired capacity of 300 MW, which is equal to the available capacity. Resource supplier 2's bid of $9.00/kW-month results in a net unit capacity price of $2.62/kW-month. According to the method of the present example, the net unit capacity price of $2.62/kW-month is what the settled unit capacity price will be based on because it corresponds to the aggregate desired capacity that at least equals the available capacity. Further, the selected bids will be defined by their position in the ordered list relative to bidder 2's italicized bid because it corresponds to the aggregate desired capacity that at least equals the available capacity.

The settled unit capacity price for each term is determined by adding the settled net unit capacity price of $2.62/kW-month to the minimum prices specified for each term. Thus, the settled unit capacity price for the term of 5 years equals $2.62+$6.38=$9.00/kW-month. Likewise, the settled unit capacity price for the term of 10 years equals $2.62+$4.93=$7.55/kW-month.

The selected bids are defined to be the bids with the highest net unit capacity prices until the aggregate desired capacity bid therein at least equals the available capacity. Stated another way, the selected bids are the bids that resulted in a net unit capacity price equal to or greater than the net unit capacity price of the bid that caused the aggregate desired quantity of the selected bids to at least equal the available capacity. Thus, in the present example the selected bids are those that are positioned above bidder 2's italicized bid in Table 3 because Table 3 is sorted into an ordered list of descending net unit capacity prices. The same result is shown graphically in FIG. 5. The aggregate capacity bid is accumulated reading from left to right. In FIG. 5 all bids contained in the dashed rectangle are awarded capacity at the same settled unit capacity price per duration term (i.e. $9.00/kW-month for the 5 year term, and $7.55/kW-month for the 10 year term).

In the method according to the present example, each resource supplier who submitted a selected bid will be entitled to purchase transmission capacity at the settled unit capacity price for the terms and capacities they bid. Those resource suppliers who's bids were not selected will not be entitled to purchase transmission capacity at any price, unless more capacity becomes available. More capacity may come available, for example by the resource suppliers who made selected bids not purchasing all of the available capacity or by the transmission capacity provider offering more transmission capacity for sale.

To demonstrate how transmission capacity may be allocated in pro-rata fashion, a brief additional example is provided. For the sake of this additional example, assume that there was an available capacity of 100 MW. The additional example provides two resource suppliers, resource suppliers A and B, who each bid personal unit capacity prices of $9.00/kW-month for a 5 year term. Assume further that resource supplier A bid a desired capacity of 100 MW and resource supplier B bid a desired capacity of 200 MW.

A pro-rata allocation is used in this example because the aggregate desired capacity of the two bidders equaled 100+200=300 MW and the available capacity was only 100 MW. The pro-rata allocation would utilize the following formula: A's allocation=[(Desired Capacity bid by A)/(Desired Capacities bid by both A and B)]*(Available Capacity). Allocating the remaining capacity pro-rata according to this formula would result in the following allocations: Resource supplier A would receive [100/(100+200)]* 100=33.3 MW; Resource supplier B would receive [200/(100+200)]*100=66.6 MW.

While embodiments of methods for pricing and allocating capacity have been particularly shown and described, many variations may be made therein. For example, the methods are applicable to pricing and allocating transmission capacity or assigning rights of use, such as with regard to right of ways, manufacturing delivery slots, airport landing slots, roadway access rights, navigable river access rights, etc. This disclosure may include one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed.

Where “a” or “a first” element or the equivalent thereof is recited, such recitations include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

Inventions embodied in various combinations and subcombinations of features, functions, elements, and/or properties may be claimed through presentation of claims in a related application. Such claims, whether they are directed to different inventions or directed to the same invention, whether different, broader, narrower or equal in scope to the other claims, are also regarded as included within the subject matter of the present disclosure.

What is claimed is:

1. A method of assigning an equal settled unit capacity price for the purchase of transmission capacity by resource suppliers who desire transmission of a resource via a common conduit comprising the steps of:
specifying an available capacity for bidding;
receiving bids from a plurality of resource suppliers, each bid specifying a desired capacity and a personal unit capacity price that the resource supplier is willing to pay for the desired capacity;
selecting the bids with the highest personal unit capacity prices until the aggregate desired capacity of the selected bids at least equals the available capacity or until all bids are selected if the aggregate desired capacity does not at least equal the available capacity; and
assigning the equal settled unit capacity price to be a function of the personal unit capacity prices bid in the selected bids.

2. The method of claim 1, wherein the equal settled unit capacity price is assigned to be the minimum personal unit capacity price bid in the selected bids.

3. The method of claim 1, further comprising the step of specifying a minimum desired capacity block that must be bid for the bid to qualify for selection.

4. The method of claim 1, wherein selecting the bids includes sorting the bids into an ordered list, the ordered list starting with the bid of the highest personal unit capacity price and progressing towards the bid of the lowest personal unit capacity price.

5. A method of allocating transmission capacity at an equal settled unit capacity price to resource suppliers who seek to transmit a resource via a common conduit, comprising the steps of:
specifying an available capacity for bidding;
receiving bids from a plurality of resource suppliers, each bid specifying a desired capacity and a personal unit capacity price that the resource supplier is willing to pay for the desired capacity;
selecting the bids with the highest personal unit capacity prices until the aggregate desired capacity of the selected bids at least equals the available capacity or until all bids have been selected if the aggregate desired capacity does not at least equal the available capacity;
assigning the equal settled unit capacity price to be a function of the personal unit capacity prices bid in the selected bids; and
allocating the available capacity at the equal settled unit capacity price to the resource suppliers who bid selected bids according the desired capacities bid in the selected bids.

6. The method of claim 5, wherein the equal settled unit capacity price is assigned to be the minimum personal unit capacity price bid in the selected bids.

7. The method of claim 5, wherein selecting bids includes sorting the bids into an ordered list, the ordered list starting with the bid of the highest personal unit capacity price and progressing towards the bid of the lowest personal unit capacity price.

8. The method of claim 5, wherein the available capacity is allocated pro rata among the selected bids if the aggregate desired capacity of the selected bids exceeds the available capacity.

9. The method of claim 8, wherein the pro rata allocation is made in proportion to the desired capacity bid in each selected bid.

10. The method of claim 5, further comprising evaluating the credit qualifications of resource suppliers based on credit criteria and selecting bids only from resource suppliers who meet the credit criteria.

11. The method of claim 5, wherein the resource includes at least one of a solid, a liquid, a gas, electricity, optical data, and electromagnetic waves.

12. The method of claim 5, wherein the common conduit includes at least one of a conveyor, a pipe, a wire, a power line, a fiber optic cable, and a radio frequency transmitter.

13. The method of claim 5, wherein the common conduit has a fixed transmission capacity.

14. The method of claim 5, wherein the bids received are confidential.

15. The method of claim 5, further comprising the steps of:
specifying a threshold capacity defining how much the aggregate desired capacity of the selected bids must be before any of the available capacity will be allocated; and
terminating the method without allocating any of the available capacity if the aggregate desired capacity of the selected bids does not at least equal the threshold capacity.

16. A method of allocating transmission capacity for different available term durations at an equal settled net unit capacity price for each term duration to resource suppliers who seek to transmit a resource via a common conduit, comprising the steps of:
specifying an available capacity for bidding;
specifying available term durations for bidding;
specifying minimum unit capacity prices for each term duration;
receiving bids from a plurality of resource suppliers, each bid specifying a desired capacity, a desired term duration, and a net unit capacity price, wherein the net unit capacity price is the amount in addition to the minimum unit capacity price for a term duration that the resource supplier is willing to pay for the desired capacity for the desired term duration;
selecting the bids with the highest net unit capacity prices until the aggregate desired capacity of the selected bids at least equals the available capacity or until all bids have been selected if the aggregate desired capacity does not at least equal the available capacity;
assigning the settled unit capacity price for each term duration to be a function of the net unit capacity prices bid in the selected bids; and
allocating transmission capacity at the equal settled unit capacity price for each term duration to the resource suppliers who bid selected bids according the desired capacities bid in the selected bids for each term duration.

17. The method of claim 16, wherein the equal settled unit capacity price for each term duration is assigned to be the minimum net unit capacity price bid in the selected bids added to the minimum unit capacity price for each term duration.

18. The method of claim 16, wherein selecting the bids includes sorting the bids into an ordered list, the ordered list starting with the bid of the highest net unit capacity price and progressing towards the bid of the lowest net unit capacity price.

19. The method of claim 16, wherein the available capacity is allocated pro rata among the selected bids if the aggregate desired capacity of the selected bids exceeds the available capacity.

20. The method of claim 19, wherein the pro rata allocation is made first to the resource suppliers who made selected bids with desired capacities for the longest term duration available in proportion to the desired capacities they bid for the longest term duration.

21. The method of claim 20, wherein the pro rata allocation is subsequently made to the resource suppliers who submitted selected bids without desired capacities for the longest term duration available, the pro rata allocation being Made in proportion to the desired capacity for the term duration of their bid.

22. The method of claim 19, wherein the resource suppliers who submitted selected bids with desired capacities for the longest term duration available are allocated their full desired capacities and the remaining capacity is allocated pro-rata to resources suppliers who submitted selected bids without desired capacities for the longest term duration available.

23. The method of claim 19, wherein the pro rata allocation is made first to the resource suppliers who made selected bids with desired capacities for the shortest term duration available in proportion to the desired capacities they bid for the shortest term duration.

24. The method of claim 16, further comprising the steps of:
specifying a threshold capacity which defines how much the aggregate desired quantity of the selected bids must be before any of the available capacity will be allocated; and
terminating the method without allocating any of the available capacity if the aggregate desired capacity does not at least equal the threshold capacity.

25. A method of assigning rights of use to bidders at an equal settled unit price comprising the steps of:
specifying an offered allotment of the right of use being offered for bidding;
receiving bids from a plurality of bidders, each bid specifying a desired allotment and a personal unit price that the bidder is willing to pay for the desired allotment;
selecting the bids with the highest personal unit prices until the aggregate desired allotment of the selected bids at least equals the offered allotment, or until all bids have been selected if the aggregate desired allotment does not at least equal the offered allotment;
assigning the equal settled unit price to be a function of the personal unit prices bid in the selected bids; and
allocating the offered allotment at the equal settled unit price to the bidders who bid selected bids according to the desired allotments bid in the selected bids.

26. The method of claim 25, wherein the rights of use include the right to use at least one of manufacturing capabilities, airport runways, waterways, and roads.
